(19) United States
(12) Patent Application Publication
(10) Pub. No.: US 2003/0051052 A1
(43) Pub. Date: Mar. 13, 2003

(54) Addressing scheme for wireless mobile clients

(75) Inventors: Yevgeniy Eugene Shteyn, Cupertino, CA (US); Thomas Chiu, Sunnyvale, CA (US)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 09/952,095

(22) Filed: Sep. 13, 2001

(51) Int. Cl. G06F 15/16

(52) U.S. Cl. 709/245; 709/218

(57) ABSTRACT

A wireless client is enabled to communicate with a data network via an access point. The access point assigns an address to the client, based on the network address of the access point itself and a unique identifier (e.g., MAC) of the client. The unique identifier is used to generate a port number that gets assigned to the client, e.g., for a certain duration. In this manner, an interruption in the wireless communication avoids assigning a new port number to the same client, which would lead to address collisions.

### FIELD OF THE INVENTION

The invention relates to an addressing scheme for use on a data network, especially, but not exclusively, for a network with mobile clients.

### BACKGROUND ART AND SUMMARY OF THE INVENTION

Under the Internet Protocol (IP) packets are routed from a source to a destination. Routers forward the packets from incoming network interfaces to outbound interfaces according to routing tables. The routing tables typically maintain the next-hop (outbound interface) information for each destination IP address, according to the number of networks to which that IP address is connected. The network number is derived from the IP address by masking off some of the low-order bits. Thus, the IP address typically carries with it information that specifies the IP node's point of attachment.

The exponential growth of the Internet has led to a shortage of IP (InternetProtocol) addresses. The currently used version of IP, referred to as IP version 4 or IPv4, uses 32 bits to designate an IP address. The address space spanned by 32 bits has about 4.3×10⁹ different addresses. The number of addresses is expected to become exhausted well before 2010.

A known solution to the problem of address shortage is Network Address Translation (NAT). NAT is a one-to-one or many-to-one IP address translation. This approach helps to preserve the limited number of registered IP addresses. For example, a router between a local area network (LAN) and the Internet maps a local IP address and a port onto a single global IP address representative of the LAN for use on the Internet. A data packet sent to the LAN is resolved based on the state of the ports in the LAN.

NAT can be static or dynamic. In static NAT a specific fixed original IP address is always translated into a specific NAT-IP address. In dynamic NAT, the NAT-IP address, to which the original IP address is translated, depends on runtime conditions. Each time a new connection is made the NAT-IP address may differ from the one assigned to the original IP address the previous time. For more background see, e.g., “Network Address Translation”, whitepaper, Enterasys Networks, Inc., 2001.

However, NAT hides the end-to-end IP addresses. This leads to problems for applications that use dynamic IP addressing schemes, such as peer-to-peer (P2P), instant messaging, video streaming, etc. A possible solution to the NAT-related problem is to use routers that address this problem, but routers require configuration by specialists, and adding such router functionality merely to resolve the NAT conflicts implies higher costs.

The problem is even more acute in wireless communication network with mobile clients. Wireless access points (APs), e.g., as used with Bluetooth or IEEE 802.11, may use NAT-like schemes to direct IP traffic to their clients. An AP has its own IP address <AP_IP> and communicates with a wireless client on a designated communication port. In order to distinguish between different clients, the AP assigns different logical port numbers (PORTs) to different clients. To external sources and destinations the client's IP address is presented as <AP_IP:PORT>. The PORT number is generated internally by the AP and used to resolve the destination for incoming IP traffic. In addition to all the problems associated with NAT mentioned above, there is another one in the situation wherein wireless clients dynamically enter and exit communications with the AP (e.g., ad hoc networking, connection loss due to range, etc): there is no guarantee that a PORT assigned to the client will stay the same during the same application session.

The inventors propose to use a unique identifier, which is representative of the client, as a seed for generating a unique address. The identifier is consistent with the wireless client's characteristics made available to the access point. The identifier includes, for example, a hardware address that uniquely identifies the device (e.g., MAC, DLC), a software signature (firmware version, certificate, configuration or login info, etc.) or a combination of the above mentioned attributes. The unique identifier is then used to generate a unique PORT number associated with the client's communications through the AP.

This unique identifier approach has also advantages for the future version of IP addressing. IP version 6, or IPv6, has been proposed to find a solution for the address deficiency in IPv4, mentioned above. The new IPv6 uses addresses of 128 bits wide, making available a number of roughly 3.4×10³⁸ different addresses. A consequence is that the address bottleneck will not exist anymore so that each piece of equipment of any user could be made IP-compliant by giving it a unique IPv6 address. The unique identifier in the invention can be used to generate a unique IPv6 style number. Then, in a legacy IPv4 network or for security reasons, the number can be used to generate a PORT number.

To ensure future (IPv6) compatibility, the AP can internally represent all clients as having IPv6 addresses. Therefore, when the network is upgraded to IPv6, the APs will use the IPv6 addressing scheme directly, bypassing the translation. Also, in a mixed IPv4/IPv6 environment, the access point can flexibly use both addressing schemes, depending on the client or network configuration.

An expiration time-out or another termination condition can be set up for the binding between the client and the PORT number. This then avoids address collision and unnecessary memory allocations for redirection tables.

For completeness, reference is made to “Mobile Networking Through Mobile IP”, a well written tutorial by Charles E. Perkins, 1997, at <www.computer.org/internet/v2n1/perkins.htm>. The Perkins document describes mobile networking: being able to continue computing when the user changes his/her computer's point of attachment to the Internet. Note that the invention as discussed above solves a different problem. In Perkins, the re-attachment that is needed occurs automatically and non-interactively. One of the problems to overcome here is caused by the way the Internet Protocol routes packets to their destinations according to IP addresses. These addresses are associated with a fixed network location. When the packet's destination is a mobile node, each new point of attachment made by the node is associated with a new network number and, hence, a new IP address, making transparent mobility impossible. Mobile IP (RFC 2002), a standard proposed by a working group within the Internet Engineering Task Force, was designed to solve this problem by allowing the mobile node to use two IP addresses: a fixed home address and a care-of address that changes at each new point of attachment. The home address is static and is used to identify TCP connections. The care-of address changes at each new point of attachment and represents the topologically significant address of the mobile node. The care-of address indicates the network number and thus identifies the mobile node's point of attachment with respect to the network topology. The home address makes it appear that the mobile node is continually able to receive data on its home network, where Mobile IP requires the existence of a network node known as the home agent. Whenever the mobile node is not attached to its home network (and is therefore attached to what is termed a foreign network), the home agent gets all the packets destined for the mobile node and arranges to deliver them to the mobile node's current point of attachment. Whenever the mobile node moves, it registers its new care-of address with its home agent. To get a packet to a mobile node from its home network, the home agent delivers the packet from the home network to the care-of address. The further delivery requires that the packet be modified so that the care-of address appears as the destination IP address. This modification is a re-direction of the packet. When the packet arrives at the care-of address, the reverse transformation is applied so that the packet once again appears to have the mobile node's home address as the destination IP address. In another aspect, consider a hybrid LAN/PAN Access Point that acts as a proxy for devices on different wireless networks. “LAN” stands for Large Area Network; “PAN” stands for Personal Area Network. For example, an IEEE 802.11b (LAN) Access Point is enabled to communicate to BlueTooth (PAN) devices and to forward IP packets from LAN to PAN. In such an arrangement, BlueTooth devices are exposed to an external network as IP devices with proper IP addresses. A Mobile IP implementation would be a too heavy to address such simplified configuration, where PAN devices typically do not migrate beyond the Access Point range. A similar configuration can be used in a WAN/PAN combination, wherein WAN access is provided via a GPRS protocol.

### BRIEF DESCRIPTION OF THE DRAWING

The invention is further explained below, by way of example and with reference to the accompanying drawing, wherein:

FIG. 1 is a diagram of a known system;

FIG. 2 is a diagram of a system in the invention; and

FIG. 3 is a flow diagram illustrating the unique address generation.

Throughout the drawing, same reference numerals indicate similar or corresponding features.

### DETAILED EMBODIMENTS

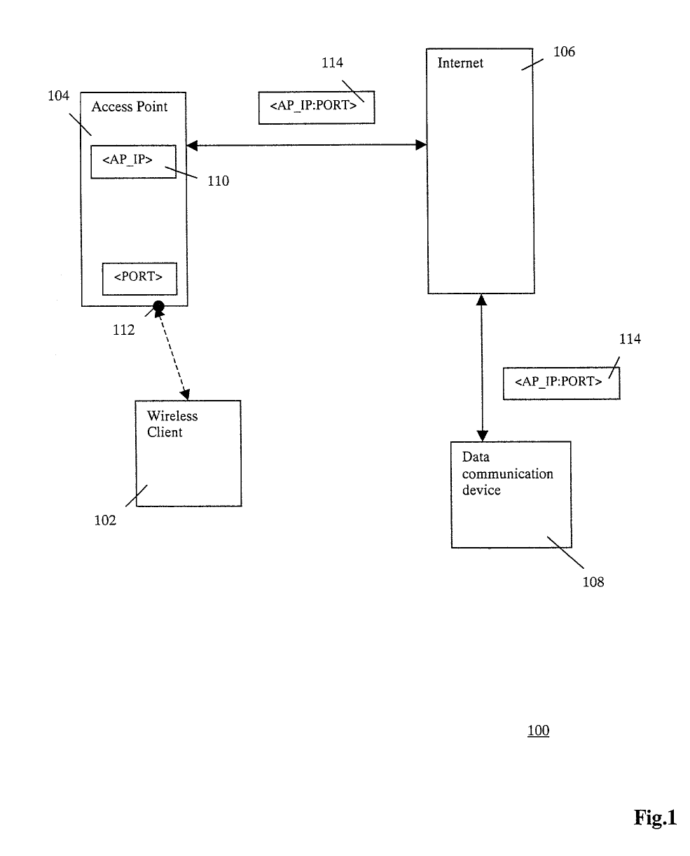

FIG. 1 is a diagram of a known data processing system 100. System 100 comprises a wireless client 102, an access point (AP) 104, a data network such as the Internet 106, and another data communication device or system 108. AP 104 has its own IP address <AP_IP> 110. AP 104 communicates with client 102 on a designated communication port 112, using a predefined protocol, e.g. IP, BlueTooth, IEEE 802.11b, etc. In order to distinguish between different clients, AP 104 assigns different logical PORT numbers to different clients. Client 102 has been assigned PORT number <PORT> in this example. To external sources and destinations, such as system 108, the IP address 114 of client 102 is presented as <AP_IP:PORT>. The PORT number is generated internally by AP 104 and used to resolve the destination for incoming IP traffic. Wireless client 102 dynamically enters and exits communication with AP 104. This is due to, e.g., ad hoc behavior of the user, to network connection loss when client 102 wanders out of range of AP 104, etc. There is no guarantee that the PORT number <PORT> as initially assigned to client 102 will remain the same during the same application session. Accordingly, as<PORT> identifies client 102 with respect to AP 104 and to system 108, data communication is not guaranteed.

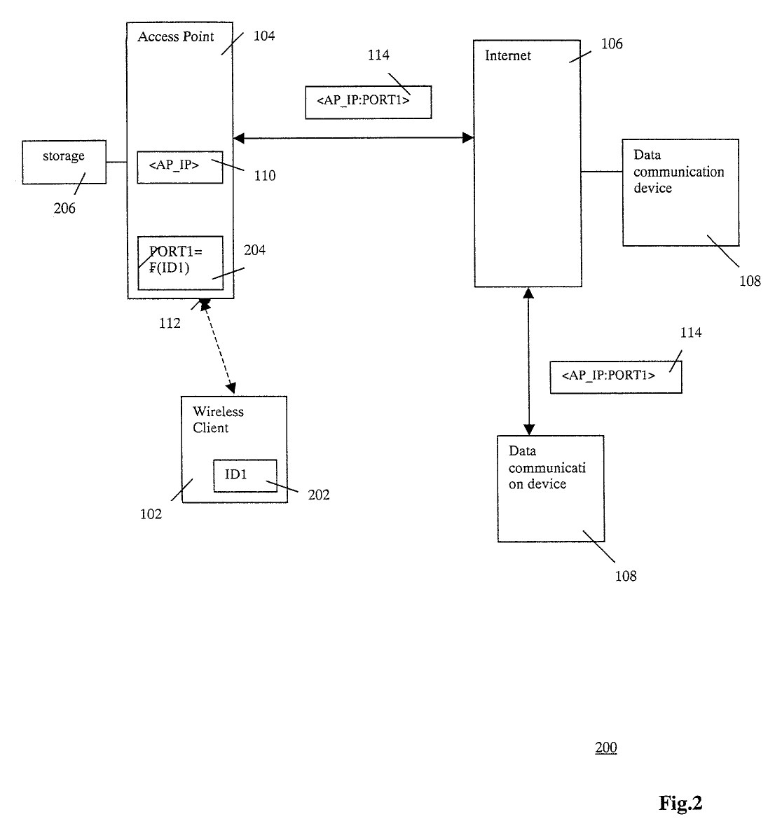

FIG. 2 is a diagram of a data processing system 200 in the invention. Client 102 has a unique identifier 202. The identifier includes, in this example, a hardware address that uniquely identifies the device (e.g., MAC, DLC) among other clients (not shown). Other examples of unique identifiers have been mentioned above. Client 102 communicates identifier 202 to AP 104 at the beginning of the session. AP 104 uses identifier 202 to generate a unique PORT number <PORT1> 204 for this client's network communications through AP 104. Another client (not shown) has another unique identifier and will be assigned another PORT number, based on that other unique identifier. Accordingly, PORT number <PORT1> is made a function of the unique identifier 202: <PORT1>=F(ID1). Now, if the connection is lost temporarily and then restored, AP 104 receives unique identifier 202 again and assigns the same PORT number <PORT1> so that the session can be resumed. To this end, AP 104 stores unique identifier 202 in storage 206 as associated with this particular PORT number <PORT1>. The association between unique identifier 202 and PORT number <PORT1> 204 is maintained for, e.g., a certain time period after communication with client 102 has ceased, or for a number of days or dependent on another predetermined condition. For example, the user of client 102 may indicate that the session has ended and that the PORT number <PORT1> can be given back for re-allocation to another client.

The PORT number generation can be carried out by access point itself or can be delegated to another party, e.g., a server (not shown) on the network.

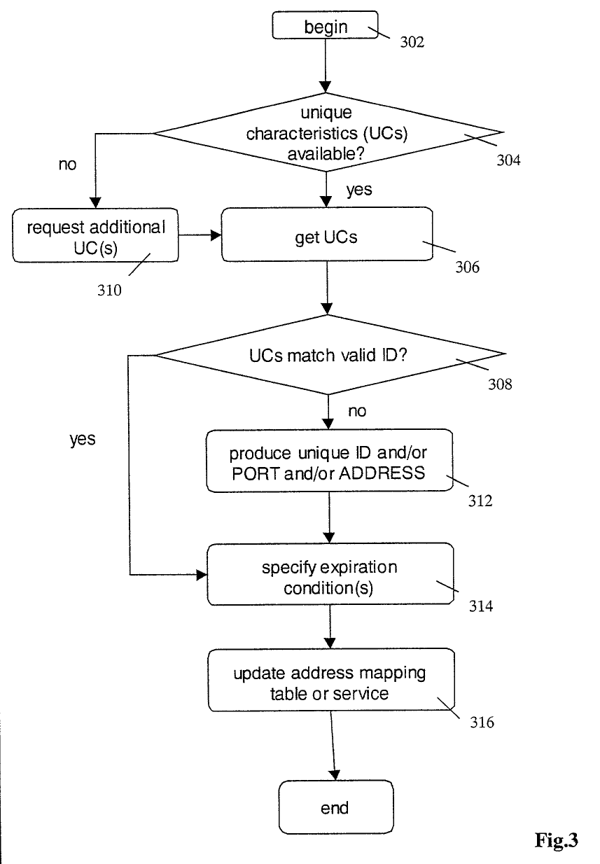

FIG. 3 is a flow diagram illustrating the unique address generation. The process begins with establishing communication with a mobile device in step 302. Then, the access point determines in step 304 if the predefined unique characteristics (UCs) of the client are available, e.g., MAC address on the first network (802.11), MAC address on the second network (BlueTooth), software driver certificate, etc. If those characteristics are available, the access point obtains them in step 306 and matches them, in step 308 against valid IDs, which are currently available in the system. If a UC or a set of UCs is not available from the client, access point requests additional UC(s) from the client in step 310. After proper UC(s) are received by the access point, the UC(s) are matched against valid Ids in step 306. A unique UC can be used as an ID or it can be used to generate an ID. If a match is not established a unique ID is established and if necessary translated into a network address (IPv6) and/or a port in step 312. Otherwise the system proceeds to establishing expiration (validity) conditions in step 314. After that, an address mapping table or service is updated in step 316 to reflect the connection parameters.

Herein incorporated by reference is U.S. Ser. No. 09/852,467 (attorney docket US 018056) filed May, 9, 2001 for Eugene Shteyn for DEVICE IDENTIFICATION AND CONTROL IN NETWORK ENVIRONMENT. This document relates to a control network for home appliances. A module is used for interfacing an appliance to the network. The module adopts the identity of the appliance when the module and the appliance are being interconnected. The appliance comprises a tag, e.g., in its power plug, with identifying information that gets read by the module and transferred to a controller. The module itself can have a location dependent identifier to enable topology dependent software applications.

What is claimed is:

1. A method of enabling a wireless client to communicate via a data network through an access point, the method comprising:
determining a unique characteristic representative of the client; and
based on the unique characteristic generating an address for use by the access point on behalf of the client for communication on the data network.

2. The method of claim 1, wherein:
the generating comprises determining a port number based on the characteristic; and
the address involves a network address of the access point and the port number.

3. The method of claim 1, wherein the unique identifier is based on a unique hardware address.

4. The method of claim 1, wherein the unique identifier is based on a software signature.

5. The method of claim 1, wherein the access point generates the address.

6. The method of claim 1, wherein the generation of the address is delegated to a server.

7. The method of claim 1, wherein the address for the client expires if a predetermined condition is met.
